(19) United States
(12) Patent Application Publication
(10) Pub. No.: US 2020/0233604 A1
(43) Pub. Date: Jul. 23, 2020

(54) INFORMATION PROCESSING APPARATUS, STORAGE CONTROL APPARATUS, AND RECORDING MEDIUM

(71) Applicant: FUJITSU LIMITED, Kawasaki-shi (JP)

(72) Inventor: Satoshi Kazama, Kawasaki (JP)

(73) Assignee: FUJITSU LIMITED, Kawasaki-shi (JP)

(21) Appl. No.: 16/739,344

(22) Filed: Jan. 10, 2020

(30) Foreign Application Priority Data
Jan. 18, 2019 (JP) 2019-006936

(51) Int. Cl. G06F 3/06; G06F 11/07

(52) U.S. Cl. CPC G06F 3/0653; G06F 3/0673; G06F 3/0619; G06F 3/0659; G06F 11/076

(57) ABSTRACT

An information processing apparatus includes a non-volatile storage device; a memory; and a processor coupled to the memory and configured to execute a scrubbing processing, the scrubbing processing including: reading out data from the storage device, determining whether a re-write of the data is required according to a result of reading out the data, and re-writing the data which has been read out at a same position in the storage device consecutively multiple times when it is determined that the re-write is required.

### CROSS-REFERENCE TO RELATED APPLICATION

This application is based upon and claims the benefit of priority of the prior Japanese Patent Application No. 2019-6936, filed on Jan. 18, 2019, the entire contents of which are incorporated herein by reference.

### FIELD

The embodiments discussed herein are related to storage control technologies.

### BACKGROUND

In recent years, storage class memories (SCMs) are drawing attention as non-volatile storage devices that realize access speeds faster than flash memories. Examples of the SCMs include, for example, magnetoresistive random access memories (MRAMs), resistive RAMs (ReRAM), phase change memories (PCMs), and the like. Such SCMs are drawing attention as storage devices to replace solid state drives (SSDs) using flash memories, for example.

On the other hand, in dynamic RAMs (DRAMs), bit inversion of memory elements due to the influence of cosmic rays and the like may occur. Scrubbing is executed in order to protect stored data from such phenomena. In scrubbing, data is read out from a DRAM during a period of low load in terms of accesses to the DRAM, for example, an inverted-bit count is detected, and values of the bits are corrected through error checking and correction (ECC). If the inverted-bit count is equal to or larger than a given number, the data which has been read out and corrected is re-written in the DRAM.

Technologies like the following one are proposed about control of memories. For example, ferroelectric memories are proposed, in which, if the total of the number of times of write-ins and the number of times of read-outs has reached a given number of times, a re-write-in is performed for all memory cells included in a memory cell array. In technologies that are proposed for flash memories mounted on electronic control units for use in vehicles, data in memories are updated before the time that has elapsed since a time of the last write-in reaches data retention time of a memory, even if operation of microcomputers is stopped.

For example, related technologies are disclosed in Japanese Laid-open Patent Publication No. 2003-007051 and Japanese Laid-open Patent Publication No. 2014-225210.

### SUMMARY

According to an aspect of the embodiment, an information processing apparatus includes a non-volatile storage device; a memory; and a processor coupled to the memory and configured to execute a scrubbing processing, the scrubbing processing including: reading out data from the storage device, determining whether a re-write of the data is required according to a result of reading out the data, and re-writing the data which has been read out at a same position in the storage device consecutively multiple times when it is determined that the re-write is required.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a figure illustrating a configuration example and a process example of an information processing apparatus according to a first embodiment;

FIG. 2 is a figure illustrating a configuration example of a storage system according to a second embodiment;

FIG. 3 is a figure illustrating a hardware configuration example of a CM;

FIG. 4 is a figure illustrating a configuration example of processing functions of a CM;

FIG. 5 is a figure illustrating a data configuration example of a scrubbing control table utilized in Process Example 1;

FIG. 6 illustrates an example of a flowchart illustrating a procedure of a normal write-in process in Process Example 1;

FIG. 7 illustrates an example (1) of a flowchart illustrating a procedure of a scrubbing control process in Process Example 1;

FIG. 8 illustrates an example (2) of a flowchart illustrating a procedure of a scrubbing control process in Process Example 1;

FIG. 9 is a figure illustrating an execution example of scrubbing in Process Examples 1 to 3;

FIG. 10 is a figure illustrating a data configuration example of a scrubbing control table utilized in Process Example 4;

FIG. 11 illustrates an example (1) of a flowchart illustrating a procedure of a scrubbing control process in Process Example 4;

FIG. 12 illustrates an example (2) of a flowchart illustrating a procedure of a scrubbing control process in Process Example 4;

FIG. 13 illustrates an example of a flowchart illustrating a procedure of a normal write-in process in Process Example 5;

FIG. 14 is a figure illustrating a data configuration example of a data characteristics table utilized in Process Example 6;

FIG. 15 illustrates an example of a flowchart illustrating a procedure of a normal write-in process in Process Example 6; and

FIG. 16 is a figure illustrating a configuration example of processing functions of a CM in a third embodiment.

### DESCRIPTION OF EMBODIMENTS

The inventors of the present application found that, with related techniques, the data retaining capability of non-volatile storage devices such as SCMs lowers with the elapse of time in some cases. If the time over which data may be retained is short, it is required to re-write data frequently.

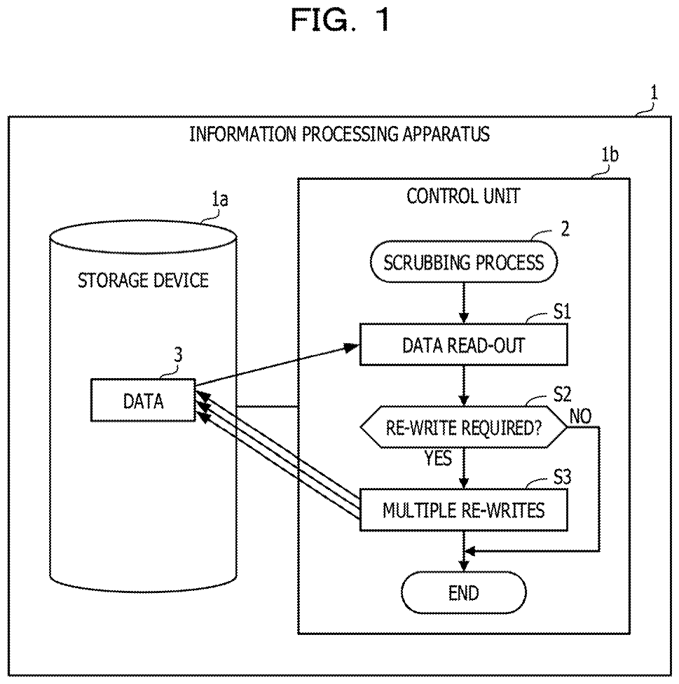

Hereinafter, embodiments discussed herein are explained with reference to drawings. FIG. 1 is a figure illustrating a configuration example and a process example of an information processing apparatus according to a first embodiment. An information processing apparatus 1 illustrated in FIG. 1 includes a storage device 1a and a control unit 1b.

The storage device 1a is a non-volatile storage device, and, for example, is an SCM. Examples of SCMs to be applied as the storage device 1a include MRAMs, ReRAMs, and PCMs, for example. The storage device 1a has characteristics that, with the elapse of time since data is written in, its data retaining capability lowers, and bit inversion occurs more easily. The inventors of the present application found through experiments that if the same data is written in the same storage area of such a storage device 1a consecutively multiple times, bit inversion occurs less easily as the number of times of the consecutive write-ins increases, and the period over which the data may be retained becomes longer.

The control unit 1b is a processor, for example. The control unit 1b utilizes the characteristics of the storage device 1a that are explained above, to execute a scrubbing process 2 like the one explained below for data stored on the storage device 1a . Here, for example, it is supposed that data 3 is stored on the storage device 1a, and the scrubbing process is executed for the data 3.

The scrubbing process 2 includes: a process of reading out the data 3 from the storage device 1a (Step S1); a process of deciding whether or not a re-write of the data 3 is required according to a result of reading out the data 3 (Step S2); and a process of re-writing the data 3 having been read out at the same position of the storage device 1a consecutively multiple times if it is decided that a re-write of the data 3 is required (Step S3). Since the data 3 is re-written consecutively multiple times at Step S3, the time over which the storage device 1a may retain the data 3 may be extended as compared with the case where the data 3 is re-written only once.

Such a scrubbing process 2 may be executed repetitively cyclically. In this case, once Step S3 is executed, and the data 3 is re-written consecutively multiple times, the probability that it is decided that a re-write of the data 3 is not required at the time of subsequent execution of the scrubbing process 2 becomes high. Thereby, the execution frequency of multiple re-writes at Step S3 is reduced. As a result, the influence of scrubbing processes on the performance in terms of accesses to the storage device 1a other than the scrubbing process 2 is reduced, and the access performance may be enhanced.

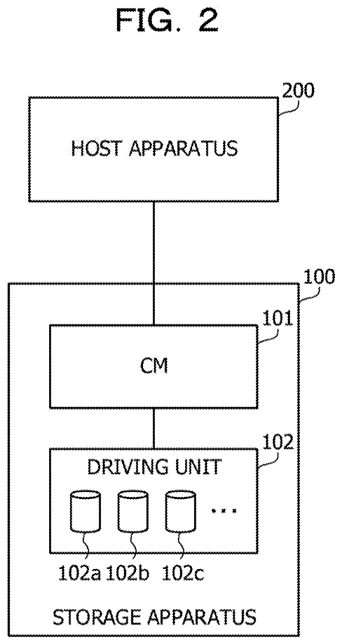

Next, a storage system is illustrated, and explained as an information processing system including the information processing apparatus 1 in FIG. 1. FIG. 2 is a figure illustrating a configuration example of a storage system according to a second embodiment. The storage system illustrated in FIG. 2 includes: a storage device 100 including a controller module (CM) 101 and a drive unit 102; and a host apparatus 200. The CM 101 is one example of the information processing apparatus 1 in FIG. 1.

The CM 101 is coupled with the host apparatus 200 via a storage area network (SAN), for example. The CM 101 is a storage control apparatus that controls accesses to storage devices 102a, 102b, 102c, . . . that are mounted on the drive unit 102 according to a request from the host apparatus 200. For example, the CM 101 generates logical volumes using storage areas of the storage devices 102a, 102b, 102c, . . . , and accepts accesses from the host apparatus 200 to the logical volumes.

A plurality of the storage devices 102a, 102b, 102c, . . . to be targets of accesses from the host apparatus 200 are mounted on the drive unit 102. Such storage devices 102a, 102b, 102c, . . . used are non-volatile storage devices such as hard disk drives (HDDs) or SSDs.

The host apparatus 200 is a server computer that executes various business processes, for example. The host apparatus 200 transmits a request to access a logical volume to the CM 101 to thereby accesses the logical volume. A plurality of such host apparatuses 200 may be coupled to the CM 101.

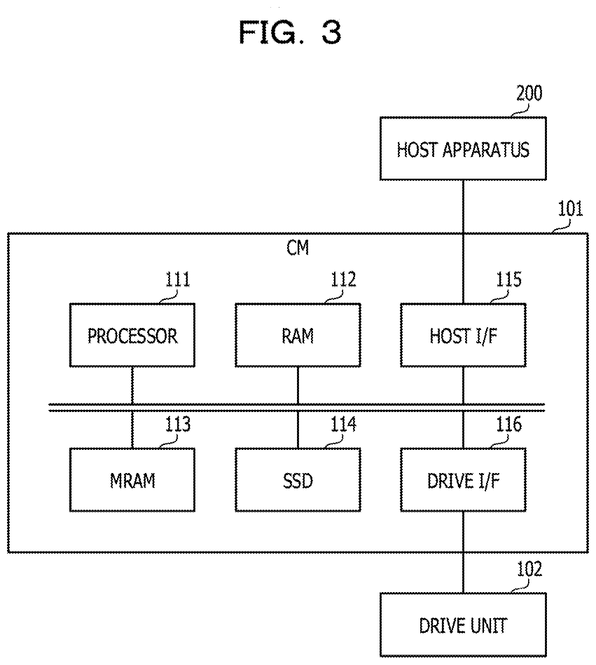

FIG. 3 is a figure illustrating a hardware configuration example of a CM. The CM 101 includes a processor 111, a RAM 112, an MRAM 113, an SSD 114, a host interface (I/F) 115, and a drive interface (I/F) 116. The processor 111 is one example of the control unit 1b in FIG. 1, and the MRAM 113 is one example of the storage device 1a in FIG. 1.

The processor 111 comprehensively controls the entire CM 101. The processor 111 is, for example, a central processing unit (CPU), a micro processing unit (MPU), a digital signal processor (DSP), an application specific integrated circuit (ASIC), or a programmable logic device (PLD). The processor 111 may be a combination of two or more elements among a CPU, an MPU, a DSP, an ASIC, and a PLD.

The RAM 112 is used as a main storage device of the CM 101. The RAM 112 temporarily stores an operating system (OS) program, and at least some of application programs that the processor 111 is caused to execute. The RAM 112 stores various types of data required for processes performed by the processor 111. For example, the RAM 112 stores cached data corresponding to data that the host apparatus 200 requested to write in a logical volume. A storage area for cached data in the RAM 112 is utilized as a primary cache, for example.

The MRAM 113 stores various types of data required for processes performed by the processor 111. The MRAM 113 provides access speed performance which is at an intermediate level between the performance of the RAM 112, and the performance of the storage devices 102a, 102b, 102c, . . . in the drive unit 102. Because of this, for example, if a partial area of the RAM 112 is utilized as a primary cache as explained above, the MRAM 113 is utilized as a secondary cache. Instead of the MRAM 113, another type of SCM such as a ReRAM or a PCM having a retention time for particular data that varies depending on the number of times of consecutive write-ins of the data may be mounted on the CM 101.

The SSD 114 is used as an auxiliary storage device of the CM 101. The SSD 114 stores an OS program, application programs, and various types of data. The auxiliary storage device that may be used includes another type of non-volatile storage device such as an HDD.

The host interface 115 is a communication interface for communicating with the host apparatus 200. The drive interface 116 is a communication interface for communicating with the storage devices 102a, 102b, 102c, . . . mounted on the drive unit 102.

The SSD 114 may not be mounted on the CM 101, but the MRAM 113 may be used as an auxiliary storage device instead of the SSD 114. Conversely, the MRAM 113 may be used as a main storage device along with the RAM 112. For example, among pieces of data that are stored on the main storage device, data which needs not be kept while the power source is shut down may be stored on the RAM 112, and data which needs to be kept while the power source is shut down may be stored on the MRAM 113.

With the hardware configuration explained above, processing functions of the CM 101 may be realized. Although not illustrated, the host apparatus 200 may also be realized as a computer including a processor, a main storage device, an auxiliary storage device, and the like.

The inventors of the present application found through experiments about MRAMs that, with the elapse of time since data is written in, their data retaining capabilities lower, and bit inversion occurs more easily. The inventors found through experiments that it is effective to re-write (rewrite) data in order to make the data retention time of an MRAM recovered. The inventors found through experiments that if the same data is written in the same storage area of an MRAM consecutively multiple times, bit inversion occurs less easily, and the period over which the data may be retained becomes longer as the number of times of the consecutive write-ins increases.

In addition to MRAMs, such characteristics are confirmed at least with ReRAMs and PCMs. These non-volatile memories store data by making use of changes of the states of materials, and presumably the data retention time becomes longer because writing the same data multiple times stabilizes the states of the materials.

Utilizing such characteristics, the CM 101 of the present embodiment is configured to write data once or consecutively multiple times at the time of the first write-in of data in an MRAM or at the time of subsequent rewrites in scrubbing. The CM 101 controls the number of times of write-ins to thereby adjust a length of time over which the data may be retained, and changes intervals at which scrubbing or rewrites is/are executed. Thereby, the execution frequency of data read-out by scrubbing and of data write-ins for rewrite is reduced, and an attempt is made to thereby minimize negative influence of execution of those operations on the performance in terms of accesses to logical volumes according to requests from the host apparatus 200.

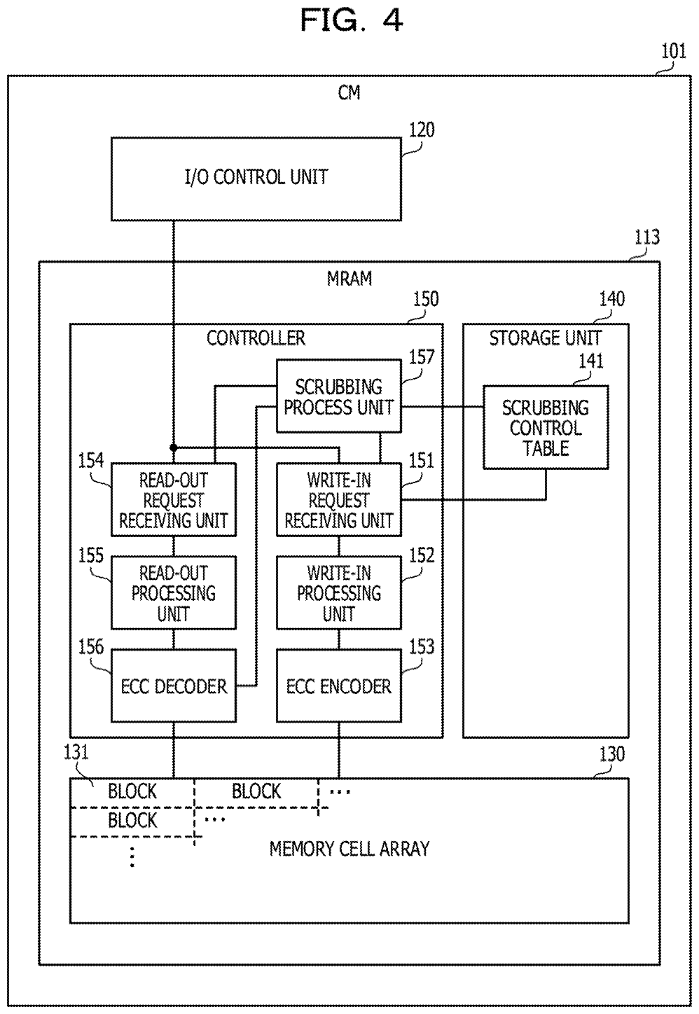

FIG. 4 is a figure illustrating a configuration example of processing functions of a CM. FIG. 4 illustrates also the hardware configuration of the MRAM 113. The CM 101 includes an input/output (I/O) control unit 120. Processes performed by the I/O control unit 120 are realized, for example, by the processor 111 executing a given application program.

The I/O control unit 120 controls accesses from the host apparatus 200 to logical volumes using storage areas of the storage devices 102a, 102b, 102c, . . . in the drive unit 102. When controlling the accesses, the I/O control unit 120 accesses the MRAM 113. For example, the I/O control unit 120 utilizes a storage area of the MRAM 113 as a secondary cache that retains cached data corresponding to data that the host apparatus 200 requested to write.

The I/O control unit 120 is one example of processing functions (applications) to access the MRAM 113, and processing functions other than it may access the MRAM 113.

The MRAM 113 includes a memory cell array 130, a storage unit 140, and a controller 150 as hardware.

A large number of memory cells in which data is retained are arrayed in the memory cell array 130. The memory cell array 130 is divided into blocks 131 each of which retains a given size of data. The size of the blocks 131 is 512 bytes, for example. The blocks 131 are written-data management units, and scrubbing is executed for each block 131 in the present embodiment.

The storage unit 140 is a storage device that stores various types of data to be utilized in processes performed by the controller 150, and is realized as a non-volatile storage device such as a DRAM. The storage unit 140 stores a scrubbing control table 141 to be referred to for controlling execution of scrubbing. The scrubbing control table 141 includes a record for each block 131 in the memory cell array 130. Each record includes the number of times of data write-ins on a corresponding block 131, and the like, for example.

The controller 150 is a control circuit that controls data read-outs and write-ins on the memory cell array 130. The controller 150 includes a write-in request receiving unit 151, a write-in processing unit 152, an ECC encoder 153, a read-out request receiving unit 154, a read-out processing unit 155, an ECC decoder 156, and a scrubbing process unit 157. At least some of processes performed by these processing functions are realized, for example, by a processor included in the controller 150 executing a given firmware program. At least some of the processes performed by these processing functions may be executed, for example, by a dedicated hardware circuit included in the controller 150.

The write-in request receiving unit 151 receives a data write-in request, and to-be-written data from the I/O control unit 120 or the scrubbing process unit 157. The write-in request receiving unit 151 outputs the to-be-written data to the write-in processing unit 152 according to the write-in request, and makes the write-in processing unit 152 execute a write-in process according to the request. Upon completion of the write-in process performed according to the write-in request from the I/O control unit 120, the write-in request receiving unit 151 updates the number of times of write-ins which is recorded in the scrubbing control table 141, and corresponds to a write-in destination block.

According to the request from the write-in request receiving unit 151, the write-in processing unit 152 writes the to-be-written data in the memory cell array 130 via the ECC encoder 153. Based on the to-be-written data, the ECC encoder 153 calculates an error check code, and writes the to-be-written data in the memory cell array 130 along with the error check code. Error check codes given to to-be-written data are different at least among different blocks 131 in the memory cell array 130.

The read-out request receiving unit 154 receives a data read-out request from the I/O control unit 120 or the scrubbing process unit 157. According to the read-out request, the read-out request receiving unit 154 makes the read-out processing unit 155 execute a process to read out data from the memory cell array 130, acquires the data which was read out, and returns it to a unit that output the read-out request.

According to the request from the read-out request receiving unit 154, the read-out processing unit 155 reads out data from the memory cell array 130 via the ECC decoder 156, and outputs the data which was read out to the read-out request receiving unit 154.

The ECC decoder 156 reads out data which was requested to be read out from the memory cell array 130 along with an error check code, and, based on the error check code, executes an error correction process on the data which was read out. If it is supposed that the number of bits that may be corrected in a data length of the unit of error correction is n, and the bit count of inverted bits (bits detected as being erroneous) is equal to or smaller than n, the ECC decoder 156 corrects the data which was read out, and outputs it to the read-out processing unit 155. In a case of a read-out process performed according to a request from the scrubbing process unit 157, the ECC decoder 156 notifies the scrubbing process unit 157 of the bit count of detected inverted bits.

The scrubbing process unit 157 executes scrubbing cyclically at given intervals. Scrubbing is executed for each block 131. Scrubbing is a process of reading out data from a block 131, and rewriting the data which was read out in the block 131 if the number of inverted bits detected at the time of reading out the data is equal to or larger than a given threshold.

If a scrubbing execution time for a certain block 131 has come, the scrubbing process unit 157 requests the read-out request receiving unit 154 to read out data from the block 131. The scrubbing process unit 157 receives, from the read-out request receiving unit 154, the data which was read out from the block 131 according to this request, and receives, from the ECC decoder 156, the bit count of detected inverted bits.

The scrubbing process unit 157 decides whether a rewrite of data is required based on the bit count of inverted bits. If the bit count of inverted bits is equal to or larger than a given threshold n1, it is decided that a rewrite is required. In that case, the scrubbing process unit 157 requests the write-in request receiving unit 151 to rewrite the data which was read out in the block 131. At this time, the scrubbing process unit 157 identifies the number of times of consecutive write-ins based on the number of times of write-ins which is recorded in the scrubbing control table 141, and corresponds to the block 131. The scrubbing process unit 157 requests to write the same data which was read out in the block 131 consecutively the identified number of times of consecutive write-ins. The scrubbing process unit 157 updates the number of times of write-ins recorded in the scrubbing control table 141 with the number of times of the consecutive write-ins that were performed.

The threshold n1 is set to a value which is smaller the number n of bits that may be corrected by the ECC decoder 156 (and is larger than 0). According to the number of times of write-ins which is recorded in the scrubbing control table 141, and corresponds to each block 131, the scrubbing process unit 157 may adjust cycles of execution (execution frequency) of scrubbing of the block 131.

Next, a plurality of process examples (Process Examples 1 to 6) are illustrated as specific examples of data write-in processes and scrubbing control processes performed by the controller 150. In Process Example 1, after data is written in a certain block 131 according to a write-in request from the I/O control unit 120, scrubbing for the block 131 is executed at given cycles. If it is decided in the scrubbing that a rewrite of the data is required, the data is rewritten consecutively multiple times in the rewrite. Such execution of consecutive rewrites extends the time over which data may be retained in the block 131; therefore, scrubbing execution cycles are extended after execution of consecutive rewrites, and the scrubbing execution frequency is reduced.

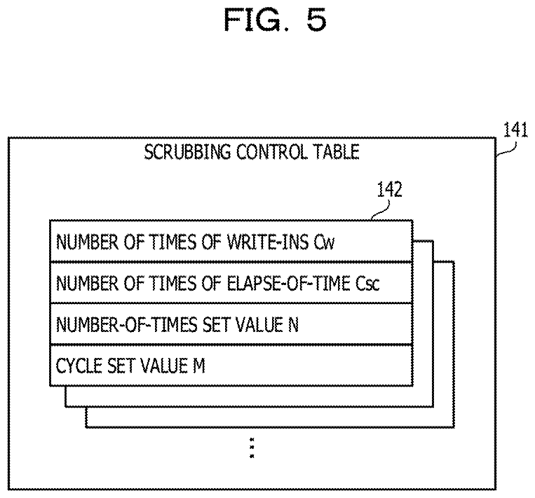

FIG. 5 is a figure illustrating a data configuration example of a scrubbing control table utilized in Process Example 1. In Process Example 1, the scrubbing control table 141 includes a record 142 for each block 131. In each record 142, number of times of write-ins Cw, number of times of elapse-of-time Csc, number-of-times set value N, and cycle set value M are recorded.

The number of times of write-ins Cw indicates the number of times of consecutive data write-ins at the time of the immediately preceding write-in process on a block 131. “Write-in processes” include write-in processes performed according to write-in requests from the I/O control unit 120, and rewrite processes in scrubbing. The number of times of elapse-of-time Csc indicates the number of times a certain length of time has passed, and scrubbing execution times that occur given scrubbing execution cycles have come since the last scrubbing was executed for the block 131. Values of the number of times of write-ins Cw and the number of times of elapse-of-time Csc are variable with the elapse of time.

The number-of-times set value N indicates the number of times of write-ins that is applied when data is written in a block 131 consecutively multiple times. In the Process Example 1,when data is written in a block 131, either a process of writing the data only once or a process of writing the data N times consecutively is executed. The cycle set value M is a set value indicating scrubbing execution cycles to be applied when the scrubbing execution frequency is reduced from a normal frequency. The cycle set value M is a value indicating how many times a scrubbing execution cycle is greater than a normal scrubbing execution cycle, and is set to an integer which is equal to or larger than two. The number-of-times set value N and the cycle set value M are fixed values that are set in advance.

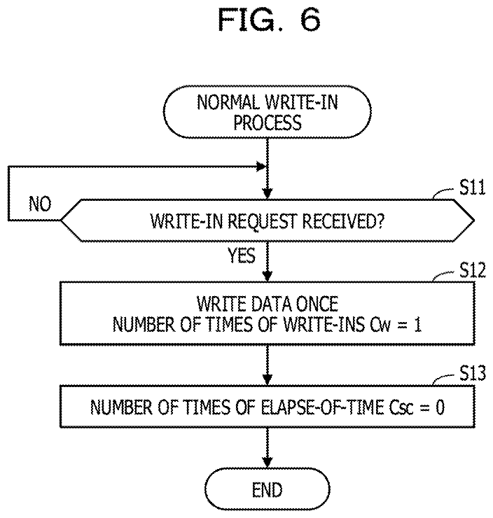

FIG. 6 illustrates an example of a flowchart illustrating a procedure of a normal write-in process in Process Example 1. “Normal write-in processes” are write-in processes executed according to write-in requests from the I/O control unit 120. If applications other than the I/O control unit 120 may access the MRAM 113, write-in processes performed according to write-in requests from these applications are also included in normal write-in processes.

[Step S11] The write-in request receiving unit 151 monitors the I/O control unit 120 for write-in requests, and upon reception of a write-in request and to-be-written data, executes the process of Step S12.

[Step S12] The write-in request receiving unit 151 requests the write-in processing unit 152 to write the to-be-written data in a write-in destination block 131 once. The write-in processing unit 152 writes the to-be-written data in the write-in destination block 131 via the ECC encoder 153 once. Upon completion of the write-in, the write-in request receiving unit 151 sets the number of times of write-ins of Cw of a record 142 that is included in the scrubbing control table 141, and corresponds to the write-in destination block 131 to “1.”

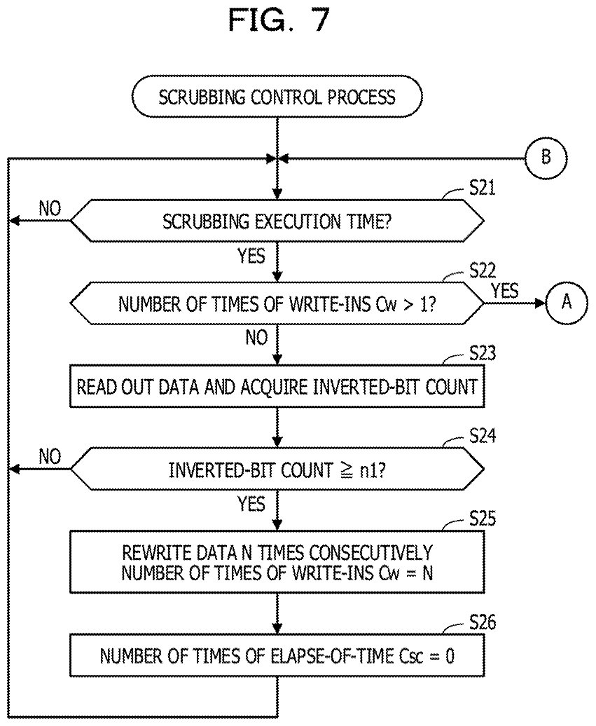

At Step S12, even if the data is written only in part of the block 131, the number of times of write-ins Cw is forcibly set to “1,” and the entire block 131 is treated as a block in which multiple, consecutive write-ins were not performed at the time of the immediately preceding write-in. Thereby, even if the data is written in only in part of the block 131, scrubbing is definitely executed on the block at a next scrubbing execution time (corresponding to Steps S23 and S24 in FIG. 7 mentioned below).

[Step S13] The write-in request receiving unit 151 resets the number of times of elapse-of-time Csc of the record 142 corresponding to the write-in destination block 131 to “0.”

As mentioned above, when the data is written in a block 131 according to a request from the I/O control unit 120, the number of times of write-ins Cw corresponding to the block 131 is set to “1.” This set value indicates that the number of times of consecutive write-ins at the time of the immediately preceding write-in process on the block 131 is “1” (for example, consecutive write-ins are not performed).

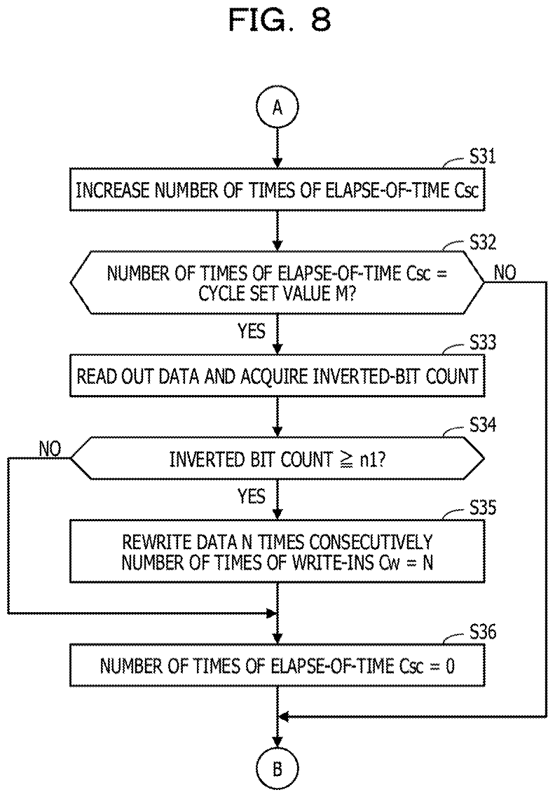

FIG. 7 and FIG. 8 illustrate examples of a flowchart illustrating a procedure of a scrubbing control process in Process Example 1. The processes of FIG. 7 and FIG. 8 are executed separately for each block 131.

[Step S21] The scrubbing process unit 157 decides whether a scrubbing execution time for a corresponding block 131 has come. If a given length of time indicating a scrubbing execution cycle has elapsed since the last scrubbing execution time for the block 131, it is decided that a scrubbing execution time has come. In that case, the scrubbing process unit 157 executes the process of Step S22. Thereby, the processes at and after Step S22 are executed at given scrubbing execution cycles.

[Step S22] The scrubbing process unit 157 reads out the number of times of write-ins Cw from a corresponding record 142 of the scrubbing control table 141. If the number of times of write-ins Cw is “1,” the scrubbing process unit 157 executes the process of Step S23, and if the number of times of write-ins Cw is larger than “1,” the scrubbing process unit 157 executes the process of Step S31 in FIG. 8.

In the former case, it is decided to execute scrubbing at normal scrubbing execution cycles, and scrubbing at Steps S23 to S26 is executed. On the other hand, in the latter case, it is decided that the scrubbing execution frequency is set to a reduced frequency, and it is decided whether to execute scrubbing at the current time at and after Step S31. In this manner, in Process Example 1, the number of times of write-ins Cw is used for deciding whether to execute scrubbing at a normal frequency or at a reduced frequency depending on whether or not the number of times of write-ins Cw is “1.” Because of this, flag information may be used instead of the number of times of write-ins Cw, for example.

[Step S23] The scrubbing process unit 157 requests the read-out request receiving unit 154 to read out data from the corresponding block 131. In response to this request, the data is read out from the block 131, and the scrubbing process unit 157 acquires, from the read-out request receiving unit 154, the data which was read out. At this time, if the number of inverted bits in the data is equal to or smaller than an allowable bit count, corrected data in which the inverted bits are corrected by the ECC decoder 156 is output from the read-out request receiving unit 154 to the scrubbing process unit 157. Along with this, the scrubbing process unit 157 acquires a detection value about the inverted-bit count from the ECC decoder 156.

[Step S24] The scrubbing process unit 157 decides whether the acquired inverted-bit count is equal to or larger than a given value (the aforementioned threshold n1). If the inverted-bit count is equal to or larger than the threshold n1, the scrubbing process unit 157 executes the process of Step S25. In this case, presumably, bit inversion of data in the block 131 has proceeded to some extent due to causes such as the time since the last write-in process becoming longer, and the data is approaching a state where it may no longer be read correctly. Because of this, a rewrite of data is executed in order to extend the time over which the data may be retained correctly. On the other hand, the scrubbing process unit 157 proceeds to the process of Step S21 if the inverted-bit count is smaller than the threshold n1. In this case, since the state where the data may be read correctly presumably lasts for a while, execution of a rewrite is skipped.

In the decision at Step S24, if there is even one piece of data whose inverted-bit count is equal to or larger than the threshold n1 in pieces of data that are read out from a block, and each have a data length of the unit of error correction, the result of the decision is “Yes,” for example, it is decided to execute rewrite.

Although not illustrated, if a detected inverted-bit count is larger than the upper limit bit count that is allowed for data correction (the aforementioned thresholds n; n>n1), a read-out error occurs, and the process of FIG. 7 ends.

[Step S25] Based on the number-of-times set value N recorded in the corresponding record 142 of the scrubbing control table 141, the scrubbing process unit 157 rewrites the data which is read out at Step S23, and has inversion-corrected bits in the block 131 N times consecutively. The scrubbing process unit 157 updates the number of times of write-ins Cw in the corresponding record 142 of the scrubbing control table 141 with “N.” Thereby, that multiple, consecutive write-ins were performed at the time of the immediately preceding write-in on the block 131 is recorded.

[Step S26] The scrubbing process unit 157 resets the number of times of elapse-of-time Csc in the corresponding record 142 of the scrubbing control table 141 to “0.” Thereafter, the process proceeds to Step S21.

Hereinafter, explanation is continued by using FIG. 8. [Step S31] The scrubbing process unit 157 increases the number of times of elapse-of-time Csc in the corresponding record 142 of the scrubbing control table 141 by “1.”

[Step S32] The scrubbing process unit 157 reads out a cycle set value M recorded in the corresponding record 142 of the scrubbing control table 141, and decides whether the increased number of times of elapse-of-time Csc is equal to the cycle set value M, for example, whether it reached the cycle set value M. If the number of times of elapse-of-time Csc reached the cycle set value M, the scrubbing process unit 157 decides that a time at which the scrubbing process is not to be skipped, but to be executed has come in a state where the scrubbing process execution frequency is reduced, and the process proceeds to Step S33. On the other hand, if the number of times of elapse-of-time Csc has not reached the cycle set value M, the scrubbing process unit 157 decides to skip execution of the scrubbing process, and the process proceeds to Step S21 in FIG. 7.

[Step S33] The scrubbing process unit 157 requests the read-out request receiving unit 154 to read out data from the corresponding block 131. In response to this request, the data is read out from the block 131, and the scrubbing process unit 157 acquires, from the read-out request receiving unit 154, the data which was read out. Along with this, the scrubbing process unit 157 acquires a detection value about the inverted-bit count from the ECC decoder 156.

[Step S34] The scrubbing process unit 157 decides whether the acquired inverted-bit count is equal to or larger than the threshold n1. If the inverted-bit count is equal to or larger than the threshold n1, the scrubbing process unit 157 decides that a rewrite of data is required, and executes the process of Step S35. On the other hand, if the inverted-bit count is smaller than the threshold n1, the scrubbing process unit 157 decides that a rewrite of data is not required, and executes the process of Step S36.

[Step S35] Based on the number-of-times set value N recorded in the corresponding record 142 of the scrubbing control table 141, the scrubbing process unit 157 rewrites the data which is read out at Step S33, and has inversion-corrected bits in the block 131 N times consecutively. The scrubbing process unit 157 updates the number of times of write-ins Cw in the corresponding record 142 of the scrubbing control table 141 with “N.” Thereby, that multiple, consecutive write-ins were performed at the time of the immediately preceding write-in on the block 131 is recorded.

Although not illustrated, similar to Step S24 in FIG. 7, if a detected inverted-bit count is larger than the upper limit bit count n that is allowed for data correction (n>n1), a read-out error occurs, and the process of FIG. 8 ends.

[Step S36] The scrubbing process unit 157 resets the number of times of elapse-of-time Csc in the corresponding record 142 of the scrubbing control table 141 to “0.” Thereafter, the process proceeds to Step S21 in FIG. 7.

In Process Example 1 illustrated in FIG. 7 and FIG. 8 explained above, data is written in a block 131 consecutively multiple times at the time of a rewrite in scrubbing. Thereby, the time over which the data may be retained is extended as compared with the case where the data is written only once. Accordingly, the probability that a rewrite is required when scrubbing is executed on the same block 131 thereafter lowers, and the rewrite execution frequency (accurately, the execution frequency of multiple, consecutive write-ins at Step S35) may be reduced. Reduction of the rewrite execution frequency may reduce the influence of execution of rewrites on the performance in terms of accesses from the I/O control unit 120 to the MRAM 113; as a result, the performance in terms of accesses from the host apparatus 200 to logical volumes may be enhanced.

In Process Example 1, data is written only once in the memory cell array 130 at the time of a normal write-in on blocks 131. Thereby, the speed of response to a write-in request from the I/O control unit 120 may be increased as compared with the case where data is written consecutively multiple times; as a result, the performance in terms of accesses from the host apparatus 200 to logical volumes may be enhanced. Multiple, consecutive write-ins on blocks 131 are executed only at the time of rewrites in scrubbing executed asynchronously with write-in requests from the I/O control unit 120. Thereby, the influence of an operation of multiple, consecutive write-ins on the performance in terms of response to write-in requests from the I/O control unit 120 may be mitigated.

In Process Example 1, immediately after a normal write-in on a block 131, scrubbing is executed at normal scrubbing execution cycles. If it is decided that a rewrite of data by scrubbing is required, the data is written consecutively multiple times in the rewrite, and the scrubbing execution cycles thereafter are extended M times. Since the data retention time is extended due to performance of multiple, consecutive write-ins in a rewrite, the safety for the data may be maintained even if the scrubbing execution cycles are extended.

In this manner, in Process Example 1, the scrubbing execution frequency is reduced after a rewrite by scrubbing is executed. Because of this, the influence of a data read-out process accompanying execution of scrubbing on the performance in terms of accesses of the I/O control unit 120 to the MRAM 113 may be reduced; as a result, the performance in terms of accesses from the host apparatus 200 to logical volumes may be enhanced.

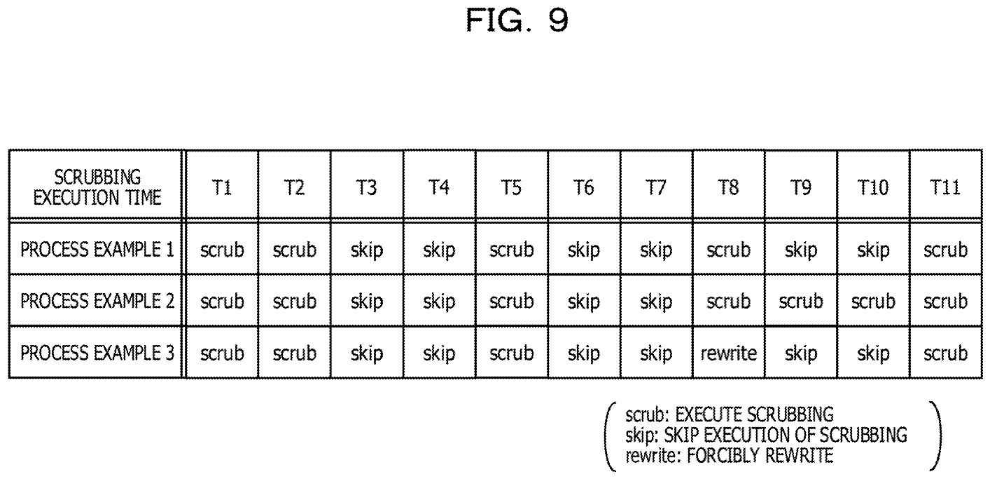

Next, Process Examples 2 and 3 in which some processes in Process Example 1 are modified are explained along with a specific example of Process Example 1. First, FIG. 9 is a figure illustrating an execution example of scrubbing in Process Examples 1 to 3. FIG. 9 illustrates scrubbing and rewrite execution examples about a particular one block 131. Scrubbing execution times (hereinafter, referred to as “execution times”) T1 to T11 illustrated in FIG. 9 are times that occur at normal scrubbing cycles. If it is supposed that scrubbing is executed at all of the execution times T1 to T11 in FIG. 9, this means that scrubbing is executed at the highest frequency. It is supposed in any of Process Examples 1 to 3 in FIG. 9 that the execution time T1 has come for the first time after a normal write-in is performed on the corresponding block 131.

In Process Example 1 in FIG. 9, scrubbing is executed at the first execution time T1 after execution of the normal write-in. At this time, if the inverted-bit count based on an error check code is smaller than the threshold n1, and a rewrite of data is not executed, scrubbing is executed again at the next execution time T2.

For example, in FIG. 9, it is supposed that a rewrite of data is performed by scrubbing at the execution time T2. At this time, multiple (N), consecutive rewrites are performed (corresponding to Step S25 in FIG. 7). Along with this, “N” is recorded as the number of times of write-ins Cw in a corresponding record 142 of the scrubbing control table 141.

As a result, the scrubbing execution cycles for the block 131 are extended M times at and after the execution time T2. For example, in FIG. 9, M=3, and execution of scrubbing is skipped at the execution times T3 and T4, and scrubbing is executed at the execution time T5. Execution of scrubbing is skipped at the execution times T6 and T7, scrubbing is executed at the execution time T8, execution of scrubbing is skipped at the execution times T9 and T10, and scrubbing is executed at the execution time T11. N consecutive rewrites are performed at the execution times T5, T8, and T11 in some cases depending on a result of detection of an inverted-bit count.

In this manner, in Process Example 1, immediately after a normal write-in on a block 131, scrubbing is performed at normal execution cycles. After a rewrite is required for the first time, multiple write-ins are performed in every rewrite, and the scrubbing execution frequency is reduced from a normal execution frequency.

Next, Process Examples 2 and 3 are explained by using FIG. 9. Process Example 2 is similar to Process Example 1 in that multiple, consecutive write-ins are performed in the first rewrite after a normal write-in, and the execution frequency of subsequent scrubbing is reduced. In Process Example 2, if scrubbing is executed a given number of times in a state where the scrubbing execution frequency is reduced, the scrubbing execution frequency is increased thereafter. Thereby, for example, it is possible to lower the possibility of occurrence of a situation where, although a rewrite has not been performed because the inverted-bit count does not increase to the threshold n1 even with execution of scrubbing several times at a low frequency, it becomes too late to correct data due to progression of bit inversion until next execution of scrubbing.

In FIG. 9, similar to Process Example 1, data is rewritten N times consecutively by scrubbing at the execution time T2, and the scrubbing execution cycles are extended M times. Thereafter, similar to Process Example 1, execution of scrubbing is skipped at the execution times T3 and T4, scrubbing is executed at the execution time T5, execution of scrubbing is skipped at the execution times T6 and T7, and scrubbing is executed at the execution time T8.

In the example illustrated in FIG. 9, if scrubbing is executed three times, the scrubbing execution cycle is shortened to a 1/M cycle, for example, a normal cycle. Accordingly, at and after the execution time T8, scrubbing is executed at the times T9, T10, and T11 at the normal execution cycles.

Process Example 3 is similar to Process Examples 1 and 2 in that multiple, consecutive write-ins are performed in the first rewrite after a normal write-in, and the execution frequency of subsequent scrubbing is reduced. In Process Example 3, every time times at which scrubbing is to be executed has come a given number of times in a state where the execution frequency is reduced, multiple, consecutive rewrites are performed forcibly. Thereby, for example, similar to Process Example 2, it is possible to lower the possibility of occurrence of a situation where, although a rewrite has not been performed even with execution of scrubbing several times at a low frequency, it becomes too late to correct data due to progression of bit inversion until next execution of scrubbing.

In FIG. 9, similar to Process Example 1, data is rewritten N times consecutively by scrubbing at the execution time T2, and the scrubbing execution cycles are extended M times. Thereafter, similar to Process Example 1, execution of scrubbing is skipped at the execution times T3 and T4, scrubbing is executed at the execution time T5, execution of scrubbing is skipped at the execution times T6 and T7, and scrubbing is executed at the execution time T8.

In the example illustrated in FIG. 9, at every second occurrence of a time at which scrubbing is to be executed after the execution time T2, N consecutive rewrites are performed forcibly. For example, the execution time T8 corresponds to the second time a time at which scrubbing is to be executed has come (corresponding to the execution times T5 and T8), and N consecutive rewrites are performed. For example, although a data read-out and acquisition of an inverted-bit count (Step S33 in FIG. 8) are performed at the execution time T8, N consecutive rewrites of data (Step S35) are performed even if the inverted-bit count has not reached the threshold n1.

After the execution time T8, times at which scrubbing is to be executed occur at extended cycles (M), and N consecutive rewrites are performed forcibly at every second occurrence of such a time. In the example illustrated in FIG. 9, execution of scrubbing is skipped at the execution times T9 and T10, and scrubbing is executed at the execution time T11.

Next, Process Example 4 is explained. In the following explanation of Process Example 4, constituent elements which are the same as those in Process Example 1, and processing steps with contents which are the same as those in Process Example 1 are illustrated with the same signs given, and explanations thereof are omitted. Process Example 4 is similar to Process Examples 1 to 3 in that data is written once at the time of a normal write-in. At the time of execution of subsequent scrubbing, the number of times of consecutive write-ins is increased every time a rewrite is executed. According to an increase of the number of times of consecutive write-ins, the scrubbing execution frequency is reduced.

Data which is in a block 131 with a large number of times of execution of scrubbing is data which is less frequently overwritten by the I/O control unit 120, and is likely remain stored for a long term. For such data, preferably the number of times of consecutive write-ins at the time of a rewrite is increased, and the data retention time is extended to thereby reduce the rewrite execution frequency. In Process Example 4, the number of times of consecutive write-ins is increased every time a rewrite is executed such that the longer the storage period of data is, the more the time over which the data may be retained may be extended, and the more the rewrite execution frequency may be reduced. By reducing the scrubbing execution frequency according to an increase of the number of times of consecutive write-ins, the scrubbing execution frequency itself may be reduced further as the storage period of data increases.

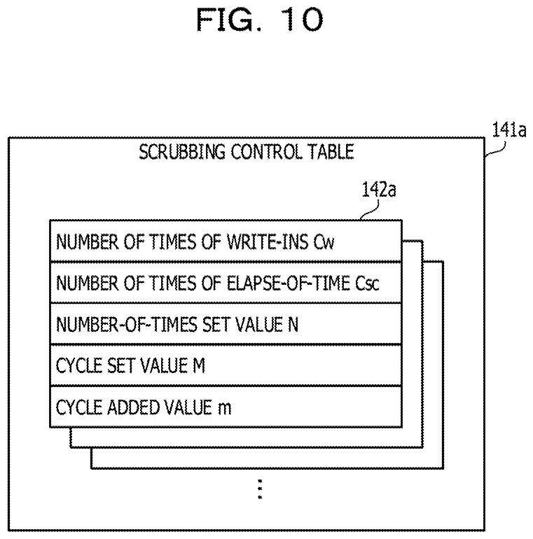

FIG. 10 is a figure illustrating a data configuration example of a scrubbing control table utilized in Process Example 4. In Process Example 4, instead of the scrubbing control table 141 illustrated in FIG. 5, a scrubbing control table 141a illustrated in FIG. 10 is utilized.

The scrubbing control table 141a includes a record 142a for each block 131. In each record 142a, a cycle added value m is recorded in addition to number of times of write-ins Cw, number of times of elapse-of-time Csc, number-of-times set value N, and cycle set value M that are similar to those in FIG. 5. The cycle added value m indicates a value to be added to a scrubbing execution cycle every time a rewrite in scrubbing is executed. In Process Example 4, the number-of-times set value N is utilized as an added value to be added to the last number of times of consecutive write-ins at every instance of execution of a rewrite.

Next, contents of processing performed in Process Example 4 are explained by using a flowchart. In Process Example 4, at the time of normal write-ins, processes similar to those in FIG. 6 are executed by using the scrubbing control table 141a instead of the scrubbing control table 141.

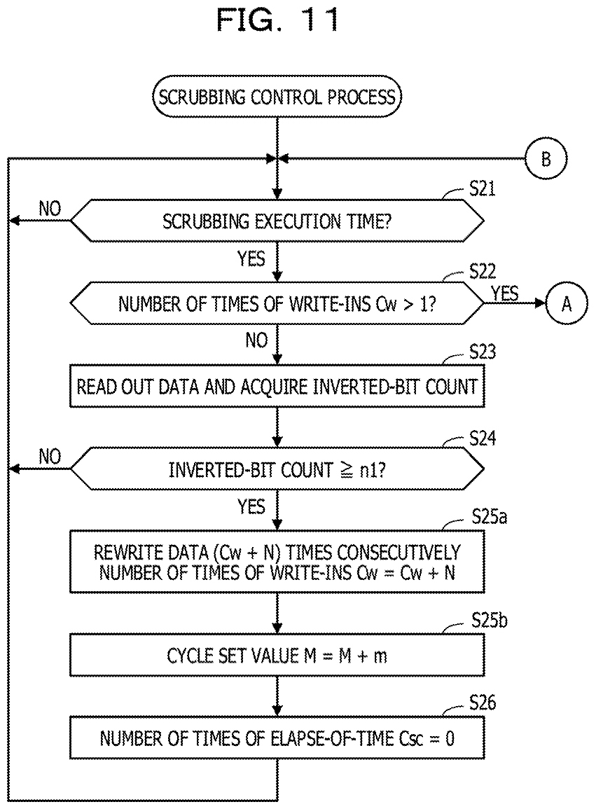

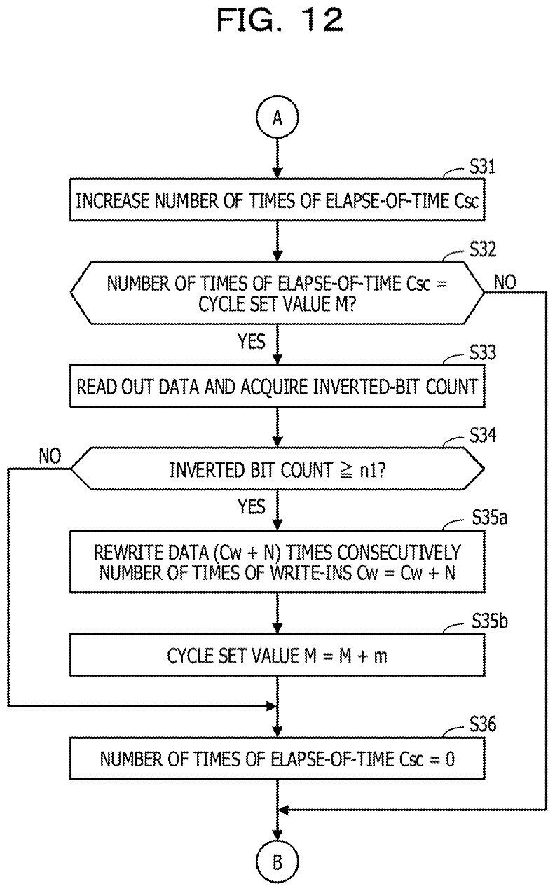

FIG. 11 and FIG. 12 illustrate examples of a flowchart illustrating a procedure of a scrubbing control process in Process Example 4. The processes of FIG. 11 and FIG. 12 are executed separately for each block 131. In FIG. 11 and FIG. 12, processing steps with processing contents similar to those in FIG. 7 and FIG. 8 are illustrated with the same step numbers given, and explanations thereof are omitted.

In the scrubbing control process in Process Example 4, if it is decided at Step S24 in FIG. 7 that an inverted-bit count is equal to or larger than the threshold n1, Steps S25a and S25b that are illustrated in FIG. 11 are executed instead of Step S25 in FIG. 7.

[Step S25a] The scrubbing process unit 157 calculates the number of times of consecutive rewrites as (Cw+N) based on the number of times of write-ins Cw, and number-of-times set value N recorded in a corresponding record 142a of the scrubbing control table 141. The scrubbing process unit 157 rewrites data which is read out at Step S23, and has inversion-corrected bits (Cw+N) times consecutively in a block 131. The scrubbing process unit 157 updates the number of times of write-ins Cw in the corresponding record 142 of the scrubbing control table 141 with “Cw+N.” Thereby, the number of times of consecutive rewrites at the time of the immediately preceding rewrite in the block 131 is recorded.

[Step S25b] The scrubbing process unit 157 updates a cycle set value M recorded in the corresponding record 142a of the scrubbing control table 141a with “M +m” based on the cycle added value m recorded in the record 142a. Thereby, the scrubbing execution cycles are extended by m.

In the scrubbing control process in Process Example 4, if it is decided at Step S34 in FIG. 8 that the inverted-bit count is equal to or larger than the threshold n1, Steps S35a and S35b that are illustrated in FIG. 12 are executed instead of Step S35 in FIG. 8.

[Step S35a] The scrubbing process unit 157 calculates the number of times of consecutive rewrites as (Cw+N) based on the number of times of write-ins Cw, and number-of-times set value N recorded in the corresponding record 142a of the scrubbing control table 141. The scrubbing process unit 157 rewrites data which is read out at Step S32, and has inversion-corrected bits (Cw+N) times consecutively in the block 131. The scrubbing process unit 157 updates the number of times of write-ins Cw in the corresponding record 142 of the scrubbing control table 141 with “Cw+N.”

[Step S35b] The scrubbing process unit 157 updates the cycle set value M recorded in the corresponding record 142a of the scrubbing control table 141a with “M +m” based on the cycle added value m recorded in the record 142a.

Next, Process Example 5 is explained. In the following explanation of Process Example 5, constituent elements which are the same as those in Process Example 1, and processing steps with contents which are the same as those in Process Example 1 are illustrated with the same signs given, and explanations thereof are omitted. In Process Example 5, at the time of normal write-ins, the number of times of write-ins is determined according to the characteristics of to-be-written data. For example, if the to-be-written data is “temporary data” which is likely overwritten in a short time, the data is written only once. On the other hand, if the to-be-written data is “long-term storage data” which is unlikely overwritten in a short term, and is aimed for long term storage, the data is written multiple times (N times in the following example) consecutively.

In this manner, unlike Process Examples 1 to 4, in Process Example 5, execution of multiple, consecutive write-ins is allowed even at the time of normal write-ins depending on characteristics of to-be-written data. Since scrubbing is likely executed the number of times for long-term storage data after the data is written, the effect of enhancing the performance in terms of accesses to the MRAM 113 that is attained by reduction of the scrubbing execution frequency is significant. Accordingly, according to Process Example 5, for such data, a higher priority is placed on the effect attained by reduction of the scrubbing execution frequency over the performance in terms of response to write-in requests from the I/O control unit 120, and data retention time is extended even at the step of a normal write-in. Thereby, the overall performance in terms of accesses to the MRAM 113 may be enhanced.

On the other hand, since temporary data is likely overwritten in a short term thereafter, scrubbing is unlikely executed repeatedly, and the effect of enhancing the performance in terms of accesses to the MRAM 113 that may be attained by reduction of the scrubbing execution frequency is marginal. Accordingly, according to Process Example 5, for such data, a higher priority is placed on the performance in terms of response to write-in requests from the I/O control unit 120 over the effect attained by reduction of the scrubbing execution frequency, and the number of times of write-ins at the time of a normal write-in is restricted to once. Thereby, the overall performance in terms of accesses to the MRAM 113 may be enhanced.

Hereinafter, contents in Process Example 5 are explained by using a flowchart. The scrubbing control table 141 (see FIG. 5) similar to that in Process Example 1 is used in Process Example 5. It is supposed that data which is requested by the I/O control unit 120 to be written in is given attribute information indicating whether the data is temporary data or long-term storage data. Alternatively, in another example, the attribute of the data may be notified by the I/O control unit 120 to the controller 150 when the data is requested by the I/O control unit 120 to be written in.

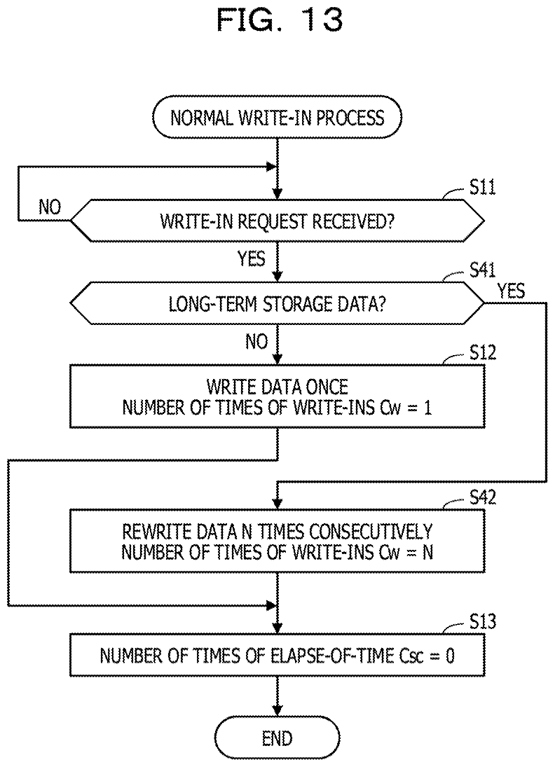

FIG. 13 illustrates an example of a flowchart illustrating a procedure of a normal write-in process in Process Example 5. In FIG. 13, processing steps with processing contents similar to those in FIG. 6 are illustrated with the same step numbers given, and explanations thereof are omitted.

In a normal write-in process in Process Example 5, a decision process at Step S41 illustrated in FIG. 13 is executed between Step S11 and Step S12 in FIG. 6. If a result of the decision at Step S41 is “Yes,” Step S42 is executed, and then Step S13 is executed.

[Step S41] The write-in request receiving unit 151 decides whether to-be-written data is long-term storage data based on attribute information given to the to-be-written data. If the to-be-written data is long-term storage data, the write-in request receiving unit 151 executes the process of Step S42, and if the to-be-written data is not long-term storage data, but is temporary data, the write-in request receiving unit 151 executes the process of Step S12. In the latter case, the to-be-written data is written in a write-in destination block 131 only once at Step S12.

[Step S42] The write-in request receiving unit 151 writes the to-be-written data N times consecutively in the block 131 based on a number-of-times set value N recorded in a corresponding record 142 of the scrubbing control table 141. The write-in request receiving unit 151 updates the number of times of write-ins Cw in the corresponding record 142 of the scrubbing control table 141 with “N.”

In Process Example 5, processes similar to those in FIG. 7 and FIG. 8 are executed for a scrubbing control process. Here, by updating the number of times of write-ins Cw with “N” at Step S42, a result of the decision at Step S22 in FIG. 7 is “Yes” even at the time of execution of the first scrubbing control process after a normal write-in. Thereby, in addition to a scrubbing execution cycle after execution of the first rewrite, cycles until execution of the first scrubbing after a normal write-in are extended N times a normal execution cycle, and the scrubbing execution frequency may be reduced further.

Next, Process Example 6 is explained. In the following explanation of Process Example 6, constituent elements which are the same as those in Process Example 1, and processing steps with contents which are the same as those in Process Example 1 are illustrated with the same signs given, and explanations thereof are omitted. Similar to Process Example 5, in Process Example 6, the number of times of write-ins is determined according to characteristics of to-be-written data at the time of a normal write-in. In Process Example 6, the number of times of write-ins according to the characteristics of to-be-written data is changed at a larger number of steps than that in Process Example 5. The scrubbing execution frequency is also changed according to the number of times of write-ins at the time of a normal write-in.

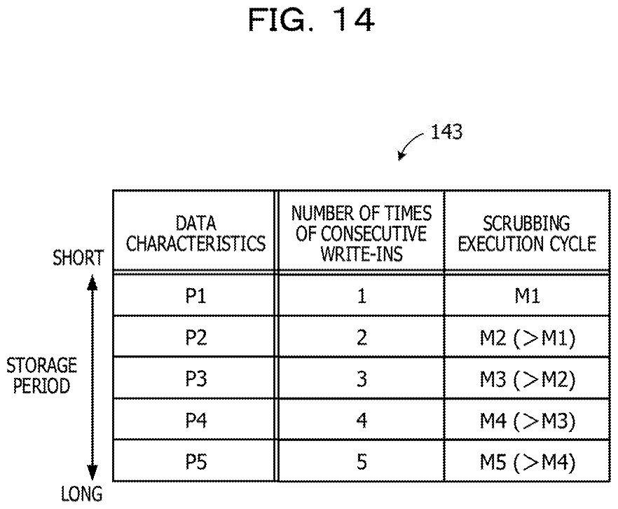

FIG. 14 is a figure illustrating a data configuration example of a data characteristics table utilized in Process Example 6. In Process Example 6, the storage unit 140 in MRAM 113 stores a data characteristics table 143 illustrated in FIG. 14, in addition to the scrubbing control table 141 illustrated in FIG. 5.

For each data characteristic of to-be-written data, the data characteristics table 143 retains the number of times of consecutive write-ins indicating the number of times of data write-ins at the time of a normal write-in, and a scrubbing execution cycle after a normal write-in. For example, in FIG. 14, data characteristics are classified into five levels, P1 to P5, according to estimated values of overwrite frequencies of to-be-written data. The overwrite frequency of to-be-written data with a data characteristic P1 is the highest, and the data has the shortest period during which the data is stored on a logical volume without being overwritten (storage period). On the other hand, the overwrite frequency of to-be-written data with a data characteristic P5 is the lowest, and the data is aimed for storage of a longer term. For example, to-be-written data with the data characteristics P1, P2, P3, P4, and P5 are presumed to have storage periods of eight hours, one week, two weeks, one month, and two months, respectively.

The lower the overwrite frequency is, and the longer the storage period is as data characteristics, the larger the number of times to which the number of times of consecutive write-ins is set is. The lower the overwrite frequency is, and the longer the storage period is as data characteristics, the longer the time to which scrubbing execution cycles are set is. In the example illustrated in FIG. 14, scrubbing execution cycles M1 to M5 are set for the data characteristics P1 to P5 (M1<M2<M3<M4<M5), respectively.

Hereinafter, contents in Process Example 6 are explained by using a flowchart. It is supposed that data which is requested by the I/O control unit 120 to be written in is given attribute information indicating data characteristics. Alternatively, in another example, the characteristics of the data may be notified by the I/O control unit 120 to the controller 150 when the data is requested by the I/O control unit 120 to be written in.

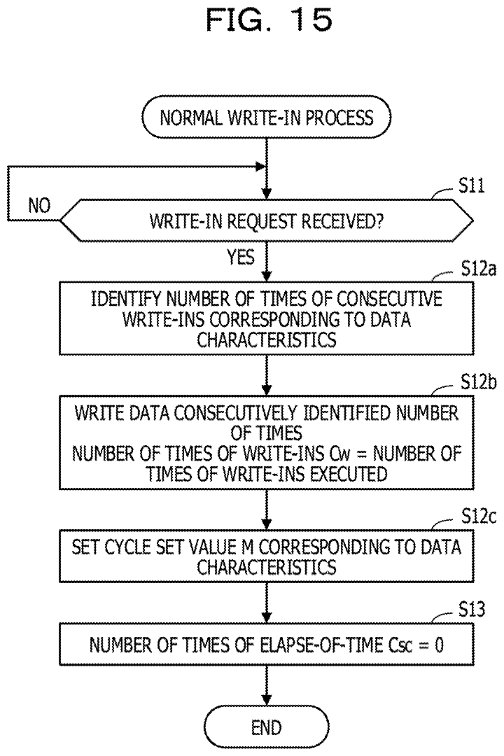

FIG. 15 illustrates an example of a flowchart illustrating a procedure of a normal write-in process in Process Example 6. In FIG. 15, processing steps with processing contents similar to those in FIG. 6 are illustrated with the same step numbers given, and explanations thereof are omitted.

In a normal write-in process in Process Example 6, Steps S12a to 12c illustrated in FIG. 15 are executed instead of Step S12 in FIG. 6. [Step S12a] The write-in request receiving unit 151 refers to the data characteristics table 143, and identifies the number of times of consecutive write-ins corresponding to data characteristics of to-be-written data.

[Step S12b] The write-in request receiving unit 151 writes the to-be-written data in a write-in destination block 131 the number of times of consecutive write-ins, which was identified at Step S12a, consecutively. If the identified number of times of consecutive write-ins is “1,” an only one write-in is performed. The write-in request receiving unit 151 updates the number of times of write-ins Cw in a corresponding record 142 of the scrubbing control table 141 with the identified number of times of consecutive write-ins, for example, the number of times the data is written in.

[Step S12c] The write-in request receiving unit 151 refers to the data characteristics table 143, and identifies scrubbing execution cycles corresponding to the data characteristics of the to-be-written data. The write-in request receiving unit 151 sets a cycle set value M in the corresponding record 142 of the scrubbing control table 141 to the value of the identified scrubbing execution cycles. Thereby, the cycle set value M corresponding to the data characteristics of the to-be-written data is set.

In the processes in FIG. 15 explained above, at Step S12b, the lower the overwrite frequency is, and the longer the storage period is as the data characteristics of to-be-written data, the larger the number of times the data is written consecutively in a write-in destination block 131 is. Thereby, for to-be-written data with the data characteristics indicating a longer storage period, a higher priority is placed on the effect attained by reduction of the scrubbing execution frequency over the performance in terms of response to write-in requests from the I/O control unit 120, and time over which data may be retained is extended even at the step of a normal write-in. Thereby, the overall performance in terms of accesses to the MRAM 113 may be enhanced.

In Process Example 6, processes similar to those in FIG. 7 and FIG. 8 are executed for a scrubbing control process. Here, the number of times write-ins are performed is set as the number of times of write-ins Cw at Step 512b. Thereby, for example, if data is written in only once at the time of a normal write-in, a result of the decision at Step S22 in FIG. 7 is “No” at the execution time of the first scrubbing control process after a normal write-in, and scrubbing is executed. In this case, scrubbing is executed at normal execution cycles after a normal write-in.

On the other hand, if data is written consecutively multiple times at the time of a normal write-in, a result of the decision at Step S22 in FIG. 7 is “Yes” at the execution time of the first scrubbing control process after a normal write-in, and scrubbing is executed at cycles longer than normal cycles based on the cycle set value M. Here, as a result of the process of Step S12c, the larger the number of times to-be-written data is written consecutively at the time of a normal write-in, the longer the scrubbing execution cycles set for the to-be-written data after a normal write-in are. Because of this, the lower the overwrite frequency is, and the longer the storage period is as the data characteristics of to-be-written data, the more the scrubbing execution frequency may be reduced immediately after a normal write-in. As a result, the overall performance in terms of accesses to the MRAM 113 may be enhanced.

In the second embodiment explained above, control of the number of times of consecutive write-ins at the time of a normal write-in, control of scrubbing execution cycles, and control of the number of times of consecutive write-ins at the time of a rewrite in scrubbing are executed by the controller 150 inside the MRAM 113. However, such control may be realized by the processor 111 of the CM 101 executing a given program. In this case, similar control may be executed also for an MRAM coupled outside the CM 101.

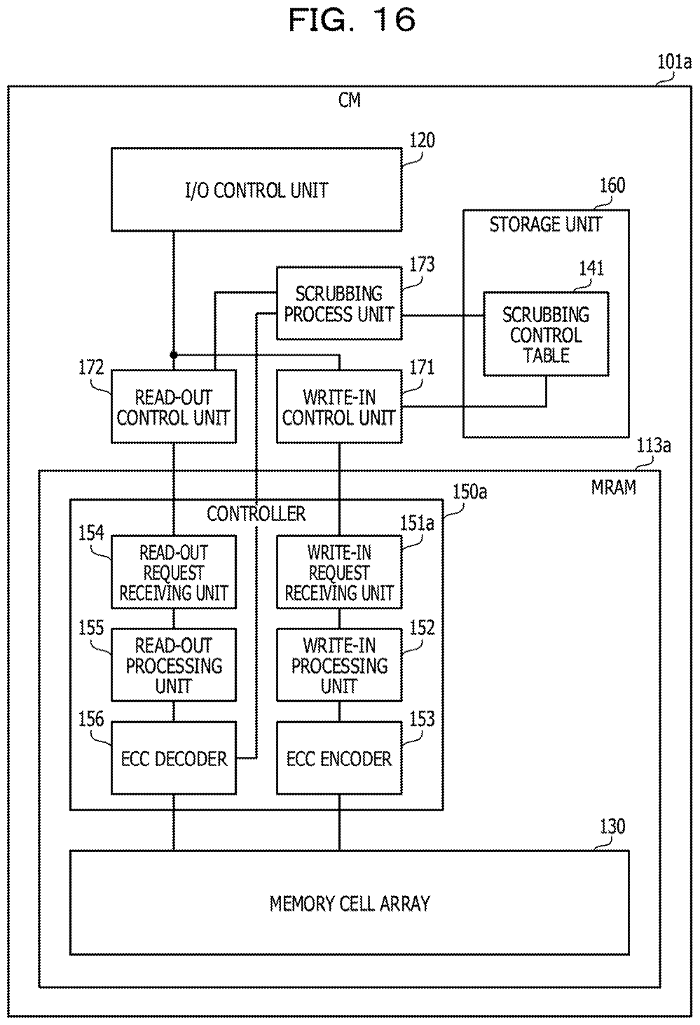

Hereinafter, a CM at which such control is performed is illustrated as a third embodiment. FIG. 16 is a figure illustrating a configuration example of processing functions of a CM in the third embodiment. In FIG. 16, constituent elements that execute processes identical to those in FIG. 4 are illustrated with the same signs given, and explanations thereof are omitted.

A CM 101a illustrated in FIG. 16 includes an MRAM 113a instead of the MRAM 113 in FIG. 4. The MRAM 113a includes a controller 150a instead of the controller 150 in FIG. 4. The controller 150a includes a write-in request receiving unit 151a instead of the write-in request receiving unit 151 in FIG. 4. The controller 150a does not include the scrubbing process unit 157 in FIG. 4.

The CM 101a includes a storage unit 160, a write-in control unit 171, a read-out control unit 172, and a scrubbing process unit 173. The storage unit 160 is realized by a storage device such as the RAM 112 provided to the CM 101a. Processes of the write-in control unit 171, the read-out control unit 172, and the scrubbing process unit 173 are realized by the processor 111 provided to the CM 101a executing a given program, for example.

The storage unit 160 stores the scrubbing control table 141 similar to the one in FIG. 4. For example, a difference from the second embodiment is that the scrubbing control table 141 is stored not inside, but outside the MRAM 113a.

The write-in control unit 171 and the read-out control unit 172 execute processes approximately similar to those of the write-in request receiving unit 151 and the read-out request receiving unit 154 in FIG. 4, respectively. If the write-in control unit 171 executes a data write-in or rewrite on the memory cell array 130, the write-in control unit 171 outputs a write-in request to the write-in request receiving unit 151a. The write-in request receiving unit 151a causes the write-in processing unit 152 to execute a write-in process according to the write-in request. If the read-out control unit 172 reads out data from the memory cell array 130, the read-out control unit 172 outputs a read-out request to the read-out request receiving unit 154. The only difference of the read-out request receiving unit 154 from the one illustrated in FIG. 4 is that it receives a read-out request not from the I/O control unit 120 or the scrubbing process unit 157 but from the read-out control unit 172.

Write-in requests from the I/O control unit 120 and the scrubbing process unit 173 are output to the write-in control unit 171. Read-out requests from the I/O control unit 120 and the scrubbing process unit 173 are output to the read-out control unit 172. The scrubbing process unit 173 executes processes similar to those of the scrubbing process unit 157 in FIG. 4.

With such a configuration, processes similar to those of the CM 101 in the second embodiment may be executed also by the CM 101a in the third embodiment. If processes similar to those in Process Example 4 are executed also in the third embodiment, the scrubbing control table 141a illustrated in FIG. 10 is utilized instead of the scrubbing control table 141. If processes similar to those in Process Example 6 are executed, the storage unit 160 stores the data characteristics table 143 illustrated in FIG. 14.

The processing functions of apparatuses illustrated in each embodiment explained above (e.g., the information processing apparatus 1 and the CMs 101 and 101a) may be realized by a computer. In that case, a program in which contents of processing performed by the functions that each apparatus is expected to have are described is provided, and the program is executed by a computer to thereby realize the processing functions explained above on the computer. The program in which the processing contents are described may be recorded in a computer-readable recording medium. Examples of the computer-readable recording medium include magnetic storage devices, optical discs, magneto-optical recording media, semiconductor memories, and the like. Examples of the magnetic storage devices include hard disk devices (HDDs), magnetic tapes, and the like. Examples of the optical discs include compact discs (CDs), digital versatile discs (DVDs), Blu-ray Discs (BDs) (registered trademark), and the like. Examples of the magneto-optical recording media include magneto-optical disks (MOs), and the like.

If the program is distributed, portable recording media such as DVDs or CDs on which the program is recorded are sold. The program may also be stored on a storage device of a server computer, and transferred from the server computer to other computers via networks.

A computer to execute the program stores, in its storage device, the program recorded in a portable recording medium or the program transferred from a server computer, for example. The computer reads out the program from its storage device, and executes processes according to the program. The computer may also read out the program directly from a portable recording medium, and execute processes according to the program. The computer may also execute processes according to the program that is received serially every time the program is transferred from a server computer coupled via a network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus, comprising:
a non-volatile storage device;
a memory; and
a processor coupled to the memory and configured to execute a scrubbing processing, the scrubbing processing including:
reading out data from the storage device,
determining whether a re-write of the data is required according to a result of reading out the data, and
re-writing the data which has been read out at a same position in the storage device consecutively multiple times when it is determined that the re-write is required.

2. The information processing apparatus according to claim 1, wherein the processor is further configured to:
write the data once in the storage device when the data is written according to a write-in request for the storage device, and
execute the scrubbing process for the data at a first cycle after the data is written according to the write-in request, and executes the scrubbing process at a second cycle after the re-write is executed for a first time in the executed scrubbing process, the second cycle being longer than the first cycle.

3. The information processing apparatus according to claim 2, wherein the processor is configured to:
execute the scrubbing process at the second cycle a given number of times, the control unit makes an execution cycle of the scrubbing process shorter than the second cycle.

4. The information processing apparatus according to claim 2, wherein the processor is further configured to:
execute the process of re-writing regardless of a result of the decision every occurrences of times for execution of the scrubbing process that occur at the second cycle, the number of the occurrences being given, and larger than one.

5. The information processing apparatus according to claim 1, wherein the processor is further configured to:
increase the number of times the data is to be re-written consecutively every time the process of re-writing is executed.

6. The information processing apparatus according to claim 1, wherein the processor is further configured to:
execute the process of re-writing, and
increase the number of times the data is to be re-written consecutively, and extends an execution cycle of the scrubbing process.

7. The information processing apparatus according to claim 1, wherein the processor is further configured to:
write the data at the same position once or consecutively multiple times when writing the data according to a write-in request for the data in the storage device, and
determine, according to a characteristic of the data, the number of times the data is to be written.

8. The information processing apparatus according to claim 7, wherein the processor is further configured to:
determine an execution cycle of the scrubbing process for the data according to the determined number of times of write-ins of the data.

9. The information processing apparatus according to claim 1, wherein the processor further configured to:
determine a re-write as being required in a case where an inverted-bit count in the data which has been read out is equal to or larger than a given number, and
correct a data having inversion-corrected bits in the data which has been read out is re-written in the storage device.

10. A storage control apparatus, comprising:
a memory; and
a processor coupled to the memory and configured to:
read out data from a storage device,
determine whether a re-write of the data is required according to a result of reading out the data, and
re-write the data which has been read out at a same position in the storage device consecutively multiple times in a case where a re-write is decided as being required.

11. A non-transitory computer-readable recording medium having stored therein a program that causes a computer to execute a storage control processing, the process comprising:
reading out data from a storage device,
determining whether a re-write of the data is required according to a result of reading out the data, and
re-writing the data which has been read out at a same position in the storage device consecutively multiple times in a case where a re-write is decided as being required.
